(19) United States
(12) Patent Application Publication
(10) Pub. No.: US 2024/0220999 A1
(43) Pub. Date: Jul. 4, 2024

(54) ITEM VERIFICATION SYSTEMS AND METHODS FOR RETAIL CHECKOUT STANDS

(71) Applicant: Datalogic USA, Inc., Eugene, OR (US)

(72) Inventors: WenLiang GAO, Eugene, OR (US); Stefano SANTI, Eugene, OR (US)

(21) Appl. No.: 18/148,877

(22) Filed: Dec. 30, 2022

(51) Int. Cl. G06Q 30/018; G06Q 20/20; G06V 10/25; G06V 10/46; G06V 10/74; G06V 10/764; G06V 10/82

(52) U.S. Cl. CPC G06Q 30/0185; G06Q 20/208; G06V 10/25; G06V 10/462; G06V 10/761; G06V 10/764; G06V 10/82

(57) ABSTRACT

The disclosure relates to a data reading system operable for obtaining and decoding data from items processed by a customer in a retail transaction, where the data reading system compares an image of the item obtained during the retail transaction to reference image data of the item to verify the identity of the item and ensure that optical code information for the item has not been altered prior to processing. If a discrepancy is identified during the data reading process, the data reading system generates an exception identifying the potential issue for further review.

### BACKGROUND

The present disclosure relates generally to data reading systems in a retail setting, and more particularly, to point-of-sale systems designed to verify the identity of an item processed by a cashier or customer during a checkout transaction.

Data reading systems in general are used in a variety of settings for reading optical codes, acquiring data, and/or capturing images of items. In a retail environment, data reading devices are well known for reading UPC and other types of optical codes (e.g., barcodes) on grocery items or packages to identify the item and add the item to the customer's transaction list for purchasing during a checkout process. In a conventional self-checkout system, the customer can scan, weigh, and pay for items without the need for assistance by a store clerk or any other personnel.

While a self-checkout system may streamline the transaction for the customer and create a faster overall checkout process, the elimination of a store clerk from the process may present potential negative impacts on profitability of the retail establishment due to an increase in the frequency of transaction errors by customers and customer theft, such as due to scan avoidance (e.g., passing an item around the data reader), label switching (e.g., replacing a barcode for a high-priced item with one for a lower priced item), or other similar actions to avoid paying for items. While these issues are more likely to occur at self-checkout systems, they may also be present in checkout lanes operated by a store clerk. For example, a store clerk may be responsible for transaction errors, or may be involved in the theft and provide customers with lower-priced items, unauthorized discounts, or free merchandise.

By some estimates, retail shrink—the loss of products from causes other than sales—accounts for approximately 1% to 2% of a retailer's bottom line. To combat retail shrink, some establishments may rely on security personnel to monitor the checkout process to ensure customers and clerks are scanning products appropriately. In some establishments, security personnel may review transaction receipts to scan for missing items or prices that seem out of place. While these measures may help reduce some instances of theft, such as for high-priced items, these measures provide a limited impact at minimizing overall retail shrink, especially in busy retail venues with large numbers of items leaving the store at a given time. In addition, the use of security personnel to review receipts or monitor transactions may be wholly ineffective at stopping most instances of theft due to label switching, which typically occurs while the customer is moving through the store and placing items into a shopping cart or basket out of view of any store personnel. Further, without comparing specific information for the items listed on the receipt with those items in the shopping cart or bags, it is unlikely that many such instances of theft would be caught.

In many conventional designs, the point-of-sale system is equipped with a platter scale for weighing items that are sold by weight (such as produce and meat) and may also include a second scale to weigh items placed in the bagging area. In this configuration, when an item is scanned or otherwise processed, the weight of the item as registered in the bagging area may be compared to the weight of the item obtained during the scanning process or compared to the expected item weight documented in an inventory management system to ensure a match. If the item weights do not match (within an acceptable tolerance), the point-of-sale system may issue an “unexpected item” alert and require reprocessing of the item. While this weight-based verification process may help curb some instances of item theft due to label switching where the items are of different weights, it will not detect theft due to label switching for items having the same or similar weights (e.g., replacing a label for an expensive bottle of wine with one for a cheaper bottle) or for items that are sold by weight (e.g., replacing a label for a steak package sold at $13.99/lb with one for bananas sold at $0.49/lb).

Accordingly, the inventors have identified a need for a point-of-sale system capable of quickly and efficiently verifying items to minimize retail shrinkage in self-checkout systems and in clerk-attended lanes. Additional aspects and advantages of such systems will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 is a data reading system operable for scanning items and processing a purchase transaction in accordance with one embodiment.

FIG. 2 is a simplified block diagram of a data reading system in accordance with one embodiment.

FIGS. 3A and 3B collectively illustrate a flowchart for a process of comparing item information obtained via the data reading systems of FIG. 1 or 2 to stored information for the item to verify a transaction.

FIG. 4 is an image captured by the data reading system for an item processed during a purchase transaction.

FIG. 5 is an example reference image data for an item label, the reference image data used to extract a reference stock descriptor for that item, the reference stock descriptor stored in a database local to the data reading system.

FIG. 6 is a cropped image illustrating a region-of-interest for a first item processed during a purchase transaction, the image highlighting specific optical characters in the region-of-interest for comparison to the retrieved reference stock descriptor.

FIG. 7 is a cropped image illustrating a region-of-interest for a second item processed during a purchase transaction, the image highlighting specific optical characters in the region-of-interest for comparison to the retrieved reference stock descriptor.

FIG. 8 is a flowchart illustrating an example Siamese (Twin) neural network for item verification in accordance with one embodiment.

FIG. 9 is a flowchart illustrating a process for comparing item information obtained via the data reading systems of FIG. 1 or 2 to stored information for the item to verify a transaction.

FIG. 10 is a representation of an item descriptor in accordance with one embodiment.

FIG. 11A is a simplified block diagram of a data reading system performing an update process in accordance with one embodiment.

FIG. 11B is a flowchart illustrating an example update process.

### DETAILED DESCRIPTION OF DISCLOSED EMBODIMENTS

With reference to the drawings, this section describes specific embodiments relating to a data reading system and its detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

With collective reference to the figures, the following disclosure relates to a data reading system, such as a self-checkout system or other suitable point-of-sale system, used in a retail setting to complete a customer transaction for the purchase of various goods offered in a retail facility. The data reading system may include any suitable components for capturing data from an item and any suitable reading engine configuration for decoding the captured data to complete the retail transaction. As further described in detail below, the data reading system is designed to capture one or more images of an item during a purchase transaction and verify the item through a streamlined comparison process. As further explained in detail below, item recognition and identification from the images during the comparison process is not necessary to ensure accuracy of the analysis. Rather, the process disclosed herein relies primarily on a comparison of image data as obtained via the data reading system to image data for the item stored in a database to ensure the matching process satisfies a predefined threshold. If the threshold parameters for the comparison process are satisfied, the transaction is verified since there is a high degree of certainty that the item was properly scanned during the customer transaction. If the parameters are not satisfied, the data reading system may trigger an exception and require action for resolving the issue, such as displaying the message to alert the customer of the potential discrepancy, or asking the customer to process the item again, or sending a message to store personnel to intervene and help with item processing.

Since the comparison process as designed does not require item-recognition functionalities, the need for computationally intensive data analysis typically associated with those processes is eliminated. Rather, the comparison processes described herein quickly and efficiently minimizes the frequency of transaction errors by customers and instances of customer theft based on more streamlined comparison techniques. Additional details of these and other embodiments of the data reading system and related methods are further discussed below with reference to the accompanying figures.

“Image data” as used herein may include raw images as well as processed images (e.g., cropped, compressed, etc.) from the raw images as well as other forms of data derived from raw image data that provides useful information for image analysis, such as descriptor data, histogram data, etc. Image data may include both individual image frames as well as multiple frames (e.g., streaming video). In some embodiments, raw images may include information arranged in two dimensions which are the x (width) and y (height) coordinates of a 2D sensor. The information at each x, y coordinate may include monochrome data, RGB data, depth data, multi-spectral data, infrared data, etc. as well as combinations thereof (e.g., RGB-depth may be captured by 3D cameras). Image data may be captured by one or more imagers arranged at various positions within the housing of the fixed retail scanner, such as in a horizontal base unit or a vertical bonnet of a bi-optic scanner having imagers positioned in two different planes. Single plane scanners (e.g., horizontal or vertical only housings) are also contemplated and are within the scope of the disclosure. Image data may also be captured by one or more imagers positioned external to the primary scanning unit, such as peripheral devices (e.g., top-down reader imagers, security imagers, bottom of basket readers, etc.) that may also provide image data to the fixed retail scanner and/or remote systems. In some cases, image data and images may be used interchangeably herein.

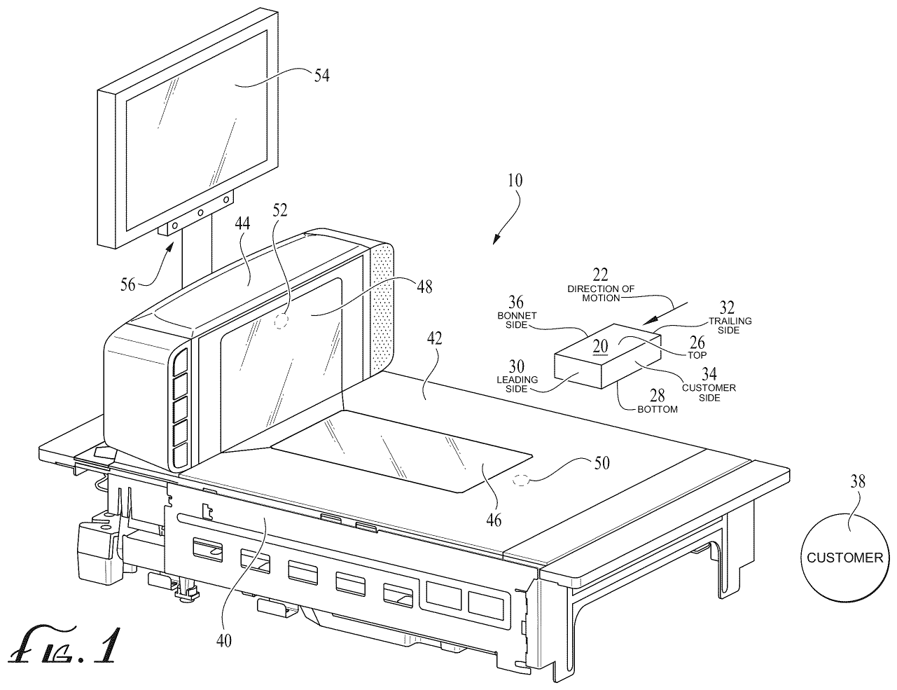

FIG. 1 illustrates an example embodiment of a data reading system 10 in accordance with one embodiment. The following section briefly describes general components of the data reading system 10 and provides an example operation of the data reading system 10 when used in a retail establishment to process a transaction. With reference to FIG. 1, the data reading system 10 is used to scan, weigh (as needed), and pay for items 20 as part of a customer transaction. In some embodiments, the data reading system 10 may be designed as a self-checkout system for processing transactions without the need for assistance by store clerk or other personnel. In other embodiments, the data reading system 10 may instead be incorporated into a checkout counter operated by a clerk. For discussion purposes, it should be understood that while the drawings and relevant discussion may reference the data reading system 10 as a self-checkout system, the scope of the disclosure incorporates other configurations.

As illustrated in FIG. 1, the data reading system 10 is operable to obtain information (e.g., optical codes, images, etc.) from an example six-sided item 20 (e.g., a grocery item) that is passed along a direction of motion 22 through a read region of the data reading system 10. For general purposes of discussion, the item 20 is represented in the figures as a six-sided, box-shaped package having a top surface 26, a bottom surface 28, a leading side 30, a trailing side 32, a customer side 34, and a bonnet side 36. While the item 20 is illustrated and described as a box-shaped package for convenience, it should be understood that the item 20 may encompass other shapes, including, for example, round fruits or vegetables, cylindrical cans, irregularly shaped packages, such as a bag of potatoes, potato chips, or the like.

The data reading system 10 may be a two-plane or bioptic reader having a lower base section 40 supporting a platter 42, and a bonnet or raised upper section 44 extending from and protruding upwardly from the platter 42 (and the lower base section 40). The data reading system 10 includes one or more data readers 50 housed within lower base section 40 underneath the platter 42, and the bonnet 44 may further include one or more data readers 52 housed therein. The data readers 50, 52 are arranged within the platter 42 and bonnet 44, respectively, to project their fields-of-view through the respective windows 46, 48 to capture and decode an optical code on the item 20 as it moves through the combined read region of the data reading system 10. In some embodiments, the data reading system 10 may incorporate any suitable optical components (not shown) within the lower base section 40 and bonnet 44 to ensure the respective fields-of-view of the data readers 50, 52 are oriented as needed to capture data from the item 20. In other embodiments, the data reading system may be a single plane reader without a bonnet or may have other suitable configurations.

For purposes of this disclosure, reference to a “data reader” is used in an expansive sense to describe any suitable device (or combination of devices) capable of obtaining and decoding coded information from an item 20. In some embodiments, a data reader may include a camera or other suitable imaging system, a processor, a decoding unit, and a controller for communicating data to other data readers or external systems for processing. In other embodiments, the data reader may include a subset of these components within a common housing and other components may be external to the data reader itself. For example, in one embodiment, the data readers may each include an imager designed to obtain images of the item 20 and to communicate those images to the decoding unit (which may be part of the processor) in an external database for decoding the coded information captured in the images and identify the item 20.

The data readers may include any suitable decoding algorithms to decode coded information from the item 20 that may be contained within one-dimensional codes, two-dimensional codes, stacked codes, or other code configurations. In this disclosure, the data readers 50, 52 may be referenced as including imagers or imaging systems, but it should be understood that the reference is meant to provide an example configuration for the data readers. Other data reader configurations may be used without departing from the principles of the disclosed subject matter. Examples of various data reader configurations include U.S. Pat. No. 8,430,318, issued Apr. 30, 2013, and entitled “SYSTEM AND METHOD FOR DATA READING WITH LOW PROFILE ARRANGEMENT,” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READER,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Patent Application Publication No. 2020/0125812, filed Dec. 2, 2019, and entitled “DATA COLLECTION SYSTEMS AND METHODS TO CAPTURE IMAGES OF AND DECODE INFORMATION FROM MACHINE-READABLE SYMBOLS,” and U.S. patent application Ser. No. 18/071,594, filed Nov. 29, 2022, and entitled “FIXED RETAIL SCANNER WITH MULTI-PORT NETWORK SWITCH AND RELATED METHODS, the disclosure of each of which is incorporated by reference herein in its entirety.

With reference to FIG. 1, the following provides an example operation of the data reading system 10 in accordance with one embodiment. During a transaction, the item 20 is moved along the direction of motion 22 across the platter 42 above the horizontal scan window 46 and in front of the vertical scan window 48. As the item 20 is moved across the scan windows 46, 48, the data readers 50, 52 cooperate to obtain image data for all sides of the item 20 to find and decode the optical code. For example, if the optical code (or other target data) is present on the bonnet side surface 36 of the item 20, the data reader 52 reading through the vertical window 48 of the bonnet 44 will capture the optical code in an image of the side surface 36 for decoding. Similarly, if the optical code is on the bottom surface 28 of the item 20, then the data reader 50 reading through the horizontal window 46 may capture the optical code in an image for decoding. Likewise, if the optical code is on any of the remaining surfaces of the item 20, one or both data readers 50, 52 (either individually or in combination) may capture image views bearing the optical code on the item 20 for decoding. If the optical code is positively captured and decoded, the data reading system 10 may emit a beeping (or other) sound indicating that the optical code was properly read, indicating to the customer 38 that the next item 20 may be processed. Alternatively, the data reading system 10 may emit a different beeping (or other) sound indicating that the optical code was not properly read and may also emit a message requesting that the customer 38 reprocess the item 20. Other feedback methods may also be provided, such as visual feedback (e.g., via an LED or an electronic display), indicating a successful read or an unsuccessful read.

As illustrated in FIG. 1, the data reading system 10 may include a display 54 operable to display information, such as a running transaction list of the items 20 purchased, images, selectable icons, text, or other suitable information to facilitate the transaction. The data reading system 10 may further include a camera 56 operable for obtaining images of the customer 38 and the items 20 to aid in the transaction as needed. In some embodiments, the display 54 may show an image of a purchased item captured by the camera 56, (and/or captured by data readers 50, 52 or other cameras internal to the data reader housing), a list of purchase items and running costs, options for identifying items by name or image, item weight, or other suitable transaction information associated with the items 20. In some embodiments, the display 54 may be a touch screen that allows the customer 38 to interact directly with the screen (or via a stylus or other suitable instrument) to enter information and respond to prompts to allow the customer 38 to manage the transaction. The touch screen may be any of several suitable display types, such as an integrated liquid crystal (LCD) display, an organic light-emitting diode (OLED) display, or other display with suitable touch screen capabilities for detecting the customer's touch via a finger, stylus, or other suitable input device.

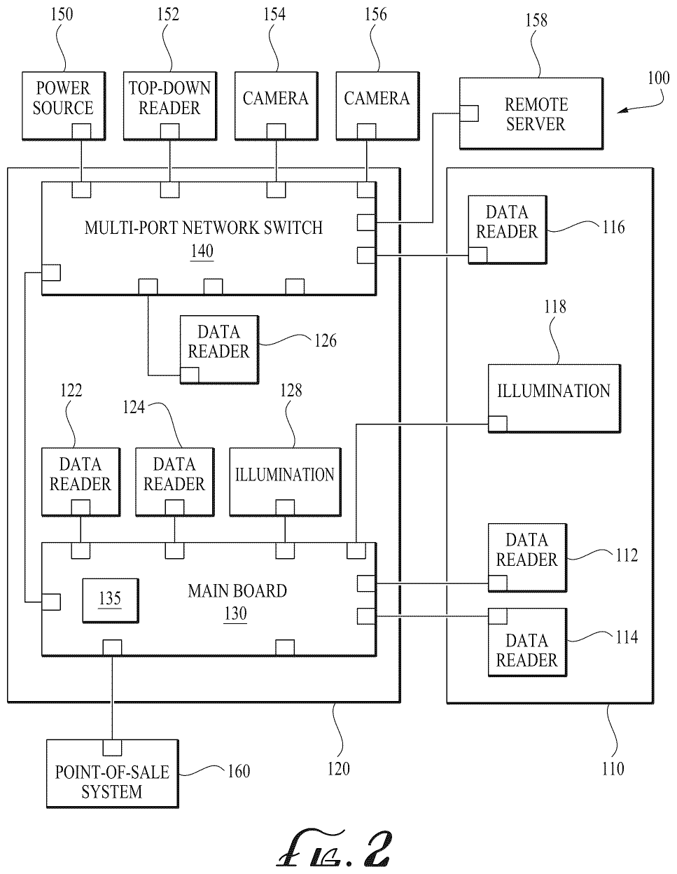

FIG. 2 is a simplified block diagram of a data reading system 100 according to an embodiment of the disclosure. As illustrated in FIG. 2, the data reading system 100 may be operably coupled with one or more of a power source 150, a top-down reader (TDR) 152, peripheral cameras 154, 156, a remote server 158, or a point of sale (POS) system 160. Additional details of the data reading system 100 are described below.

With reference to FIG. 2, the data reading system 100 may be a bi-optic fixed retail scanner having a vertical housing 110 and a horizontal housing 120 (in a similar fashion as the data reading system 10 of FIG. 1) in some embodiments. The data reading system 100 may be installed in a retail environment (e.g., grocery store), which typically is disposed within a counter or other support structure of an assisted checkout lane or a self-checkout lane. The vertical housing 110 provides an enclosure for one or more data readers 112, 114, 116, active illumination assemblies 118 (e.g., LED assemblies), and other optical elements (e.g., lenses, mirrors, etc.) and electrical elements (e.g., cables, circuit boards, etc.) therein. Similarly, the horizontal housing 120 provides an enclosure for one or more data readers 122, 124, 126, active illumination elements 128 (e.g., LED assemblies), and other optical elements (e.g., lenses, mirrors, etc.) and electrical elements (e.g., cables, circuit boards, etc.) therein. Depending on the arrangement and orientation of the different opto-electrical elements, certain elements related to providing a horizontal field of view may be physically located within the vertical structure and vice versa.

In one embodiment, the data reading system 100 may include one or more different types of data readers, such as monochrome imagers and/or color imagers. For example, data readers 112, 114 in vertical housing 110 may be monochrome imagers configured to capture monochrome images through the vertical window of the data reading system 100. Likewise, data readers 122, 124 in horizontal housing 120 may be monochrome imagers configured to capture monochrome images through the horizontal window of the data reading system 100. Data reader 116 in vertical housing 110 may be a color camera module configured to capture color images through the vertical window of the data reading system 100. Likewise, data reader 126 in horizontal housing 120 may be a color camera module configured to capture color images through the horizontal window of the data reading system 100. In such embodiments, monochrome images may be analyzed (e.g., by a decoder) to decode one or more indicia (e.g., 1D barcodes, 2D barcodes, optical character recognition, digital watermarks, etc.), and color images may be analyzed (e.g., by an image processor) where color information may be particularly advantageous, such as produce recognition, item recognition or verification, and security analysis. Such analysis may be performed by local and/or remote processors that may contain an artificial intelligence (AI) engine or otherwise configured to perform other machine learning techniques.

The data reading system 100 may further include a main board 130 and a multi-port network switch 140. As shown herein, the main board 130 and the multi-port network switch 140 may be disposed within the horizontal housing 120 in one embodiment. Bi-optic readers tend to have a larger horizontal housing (as compared to the vertical housing), which provides support for the device within a cavity in a counter and provides space to support a scale (not shown) used to weigh produce or other items sold by weight or otherwise perform weighing of items when placed on the horizontal surface (often called a “weigh platter”). It is contemplated that other embodiments may instead include the main board 130 and/or the multi-port network switch 140 within the vertical housing 110. In an embodiment where one of the multi-port network switch 140 or the main board 130 is disposed within the vertical housing 110 and the other is disposed within the horizontal housing 120, the two boards may be generally oriented orthogonal to each other similar to the orientation of the windows or another angled relationship (e.g., slightly angled orientations such as being in the range of +10° from orthogonal). The ports may be at least somewhat aligned in the orthogonal direction or other arrangement to accommodate easy connection of network cables therebetween.

The main board 130 may be operably coupled with the data readers 112, 114 and the data readers 122, 124, such as via a communication interface (e.g., a MIPI interface) or other suitable interface. The main board 130 may have decoding software embedded therein such that one or more on-board processors 135 may receive monochrome images to perform decoding on the optical indicia and provide the decoding result to a point of sale (POS) system 160 operably coupled thereto to complete a transaction. The one or more on-board processors 135 may also be configured to provide control (e.g., coordination or synchronization) of the various components of the system including camera exposure and timing of active illumination assemblies 118, 128 of the system. Although a single block is shown representing one or more on-board processors 135, it is contemplated that some embodiments may include multiple processing components (e.g., microprocessors, microcontrollers, FPGAs, etc.) configured to perform different tasks, alone or in combination, including object detection, system control, barcode decoding, optical character recognition, artificial intelligence, machine learning analysis, or other similar processing techniques for analyzing the images for product identification or verification or other desired events.

In one embodiment, the multi-port network switch 140 may be operably coupled to data reader 116, data reader 126, and with main board 130 located within the data reading system 100. Multi-port network switch 140 may also be operably coupled to the power source 150 as well as peripheral devices such as the TDR 152, peripheral cameras 154, 156, and/or the remote server 158. The number and types of peripheral devices may depend on a desired application within a retail environment. The TDR 152 may be configured as a stand connected to the data reading system 100 that typically provides a generally close overhead (angled) view of the read-zone to provide a top view of a product whereas internal data readers 112, 114, 116, 122, 124, 126 may be better suited for capturing images of the bottom and/or sides of the object within the read-zone. In some embodiments, peripheral cameras 154, 156 may be located remotely from the data reading system 100 such as being mounted on a ceiling or wall of the retail environment to provide additional views of the read-zone or checkout area. Such views may be useful for security analysis of the checkout area such as product verification, object flow, and human movements with the retail establishment. Such analysis may be performed by a remote service or other local devices (e.g., located on or otherwise coupled to the main board 130 or ethernet switch 140). Other peripheral devices may be located near the data reading system 100, such as a peripheral presentation scanner resting or mounted to a nearby surface, and/or a handheld scanner that also may be used for manual capturing by the user (e.g., checkout assistant or self-checkout customer). Such devices may be coupled directly to the main board 130 in some embodiments or to the multi-port network switch 140 if so enabled. As shown, the POS 160 may be coupled directly to the main board 130. Such a connection may be via communication interfaces such as USB, RS-232, or other such interfaces. In some embodiments, the POS 160 may be coupled directly to the multi-port network switch 140 if so enabled (e.g., as an ethernet connected device).

The multi-port network switch 140 may be implemented on a separate board from the main board 130. In some embodiments, the multi-port network switch 140 may be implemented on the main board 130 that also supports the one or more processors 135. The multi-port network switch 140 may include a plurality of ports to provide advanced network connectivity (e.g., Ethernet) between internal devices (e.g., CCMs 116, 126) within the data reading system 100 and external devices (e.g., TDR 152, peripheral camera(s) 154, 156, remote server 158, etc.) from the data reading system 100. Thus, the multi-port network switch 140 may provide an Ethernet backbone for the elements within the data reading system 100 as well as for external devices coupled to the data reading system 100 for control and/or managing data flow or analysis. As an example, multi-port network switch 140 may be implemented with a KSZ9567 Ethernet switch or other EtherSynch® product family member available from Microchip Technology Inc of Chandler, Arizona or other similar products or devices configured to provide network synchronization and communication with network-enabled devices. Embodiments of the disclosure may include any number of ports supported by the multi-port network switch to couple to both internal devices (e.g., main board, cameras, etc.) and external devices (e.g., peripheral cameras, TDR, illumination sources, remote servers, etc.) to provide a flexible platform to add additional features for connecting with the data reading system 100.

Although FIG. 2 shows one block for active illumination assemblies 118, 128 in each of the vertical and horizontal housings 110, 120, some embodiments may include multiple such assemblies in each of the horizontal and vertical housings 110, 120 to provide for different lighting options at different angles across the read-zone. For example, the vertical housing 110 may include two (or more) illumination assemblies therein at different locations and/or different colors for a desired illumination field from the vertical view. Likewise, the horizontal housing 120 may include two (or more) illumination assemblies therein at different locations and/or different colors for a desired illumination field from the horizontal view. As shown herein, the illumination assemblies 118, 128 may be coupled directly to the main board 130. However, in some embodiments, additional components may be coupled within the path from the main board 130 such as a control panel or other such device. In yet other embodiments, the illumination assemblies 118, 128 may be coupled to the multi-port network switch 140 which may route triggering controls from the main board 130. TDR 152 and one or more of the peripheral cameras 154, 156 may also include associated illumination assemblies. Synchronization of such illumination sources may be managed by the multi-port network switch 140 as controlled by the main board 130. In some embodiments, the multi-port network switch may employ or leverage IEEE1588 Precision Time Protocol to synchronize the illumination system with remote cameras, which may enable clock accuracy in sub-microsecond range.

In operation, images may be captured by the data readers 112, 114, 116, 122, 124, 126. Monochrome images may be captured by monochrome data readers 112, 114, 122, 124 and color images may be captured by color data readers 116, 126. The multi-port network switch 140 may be configured to coordinate (e.g., synchronize) timing of camera exposure and active illumination (e.g., white illumination) with the color data readers 116, 126 (as controlled by the controller on the main board 130) to occur in an offset manner with the timing of the camera exposure and active illumination (e.g., red illumination) with the monochrome data readers 112, 114, 122, 124.

Image data (e.g., streaming video, image frames, etc.) from the color data readers 116, 126 may be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the color images internally within the data reading system 100 by the one or more processors 135 supported by the main board 130. In some embodiments, barcode decoding may also be performed on the color images internally within the data reading system 100 by the one or more processors 135 supported by the main board 130. Image data from the color data readers 116, 126 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the color images externally to the data reading system 100 by external devices coupled through the multi-port network switch 140. Such color images or other data stream may be routed directly to the network connected external devices through the multi-port network switch 140 without first being received by the main board 130 (if at all). In other words, image data may be communicated (e.g., passed) from at least one imager internal to the data reader through the at least one multi-port network device 140 and on to at least one external device bypassing the main board 130. Having a connection to both the main board 130 as well as to external devices via the multi-port network switch enables image data to be provided to internal as well as external processing resources.

Image data from the monochrome data readers 112, 114, 122, 124 may be provided to the main board 130 to the processing/analysis modules located internal to the data reading system 100 such as the one or more processors 135 supported by the main board 130. As such, barcode decoding may also be performed on the color images internally within the data reading system 100 by the one or more processors 135 supported by the main board 130. In some embodiments, image analysis (e.g., AI, machine learning, OCR, object recognition, item validation, produce recognition, analytics, etc.) may be performed on the monochrome images internally within the data reading system 100 by the one or more processors 135 supported by the main board 130. Image data from the monochrome data readers 112, 114, 122, 124 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the monochrome images externally to the data reading system 100 by external devices coupled through the multi-port network switch 140. Such monochrome images or other data stream may be routed directly to the network connected external devices to the multi-port network switch 140 after first being received by the main board 130.

Image data (e.g., streaming video, image frames, etc.) from the TDR 152 or other external peripheral cameras 154, 156 may be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the images (e.g., color and/or monochrome) internally within the data reading system 100 by the one or more processors 135 supported by the main board 130. In some embodiments, barcode decoding may also be performed on such images internally within the data reading system 100 by the one or more processors 135 supported by the main board 130. Image data from the TDR 152 or other external peripheral cameras 154, 156 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on these images externally to the data reading system 100 by external devices coupled through the multi-port network switch 140. Such images or other data stream may be routed directly to the network connected external devices through the multi-port network switch 140 without first being received by the main board 130 (if at all).

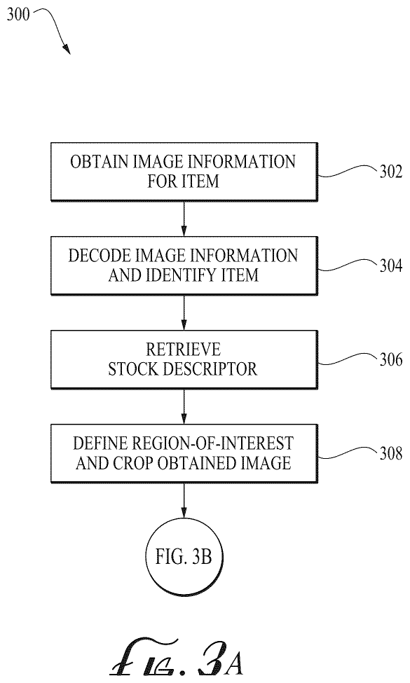

As described in further detail below with reference to FIGS. 3-9, in addition to processing purchases from the customer 38, the data reading systems 10, 100 described with reference to FIGS. 1-2 are operable to obtain one or more images of the item 20 during the checkout transaction, identify the item 20 by processing an optical code captured in the images and/or other information received by the data reading system 10, 100, retrieve a stored stock descriptor relating to the identified item, run at least one image analysis method for extracting discriminative information (i.e., optical character recognition, feature extraction, fingerprint) from the obtained item image, and compare the extracted discriminative information to the stock descriptor to verify the transaction.

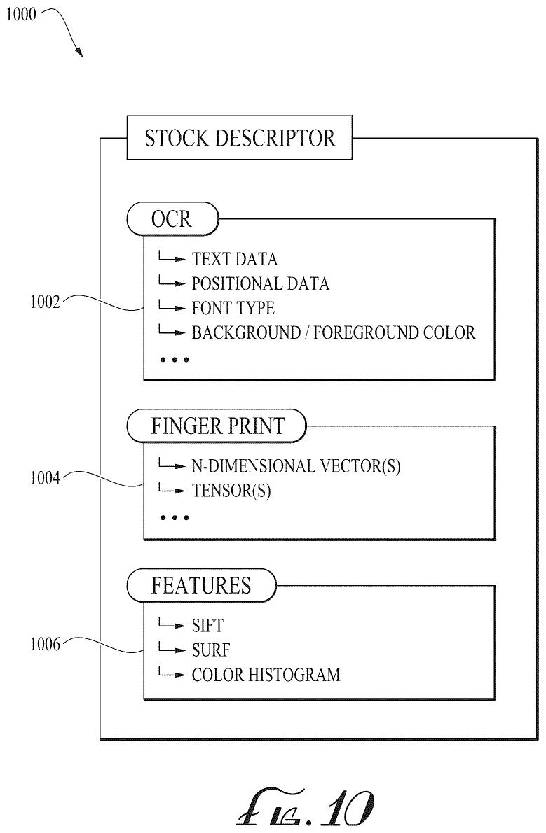

In some embodiments, a typical item descriptor includes one or more data fields in some hierarchal representation and in support of the item validation process. For example, an item descriptor could have the representation illustrated in FIG. 10, where a variety of reference information is listed: OCR (such as the words and characters, their relative position to the optical code, foreground and background color and other properties that could be related to text), fingerprint (one or more n-dimensional vectors or tensors that represent, for the reference item, the values of one or more inner layers of one or more neural network based model) and other features (that may include traditional descriptors such as SIFT, SURF, etc.). Typically, the memory footprint of a descriptor is relatively small and up to several thousand descriptors could be stored in a small database local to the data reading system 10 for efficient descriptor retrieval and real-time item validation.

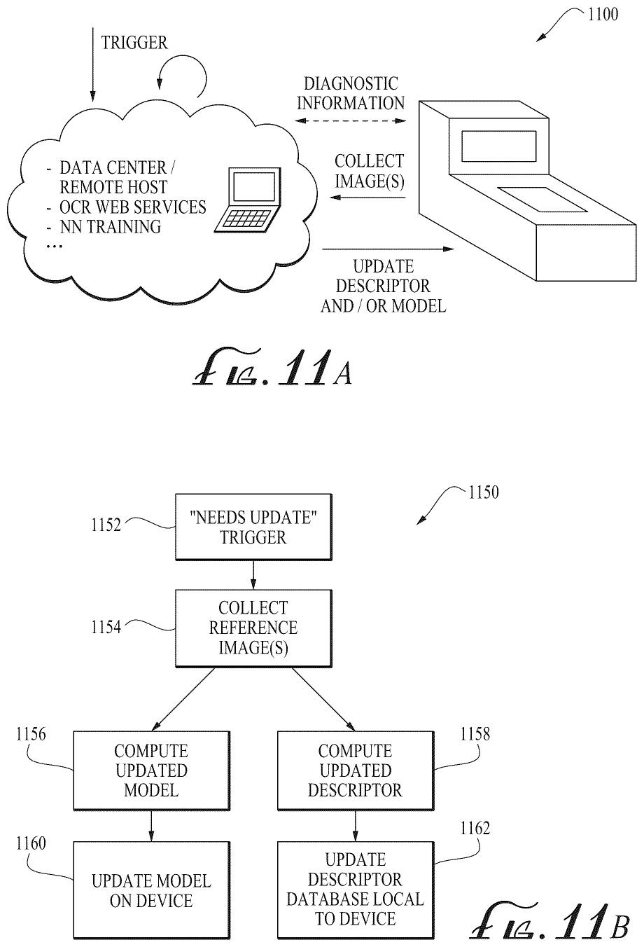

Nonetheless, the local descriptor database may be updated, based on the application specific triggers, through the interaction with an external host, server, or cloud. For example, a new item descriptor could be added to the local descriptor database to account for an inventory change, or a previously present item has to be removed from the local descriptor database, or a descriptor locally resident has to be modified to account for printing variation of the same item. In addition, the inference models, both for the OCR branch and for the SNN branch, may be updated when requested and in response to other triggers. For example, if a model is detected to be performing poorly, the server may retrain the model for recovering the expected accuracy. An example of an updating process is illustrated in FIG. 11B.

As noted previously, one advantage of the data reading systems 10, 100 disclosed herein is that they are designed to minimize potential theft of items 20, where the theft is perpetrated by swapping optical codes from more expensive items with those from cheaper items. Additional details of these and other embodiments are described below with reference to FIGS. 3-9.

For convenience and to avoid repetition, the following discussion of the subject matter illustrated in FIGS. 3-9 proceeds primarily with reference to the data reading system 10 of FIG. 1, but it should be understood that the same methods described with reference to FIGS. 3-9 apply equally to the data reading system 100 of FIG. 2 or other data reading system with other suitable configurations.

FIGS. 3A and 3B collectively illustrate a flowchart of a method 300 for comparing item information obtained for the item 20 via the data reading system 10 to stored information for the item to verify a purchase transaction. As noted above, a primary focus of the method 300 is to detect instances of potential optical code manipulation between items 20 by determining whether the item information obtained or entered into the data reading system 10 during a checkout transaction matches stored stock information (e.g., from a reference descriptor) for the purported item. As used herein, the terms “reference” and “stock” may be used interchangeably. If the two sources of information do not properly match, the data reading system 10 identifies that occurrence as an exception and flags the transaction for resolution by store personnel or for other actions to be taken as further described in detail below.

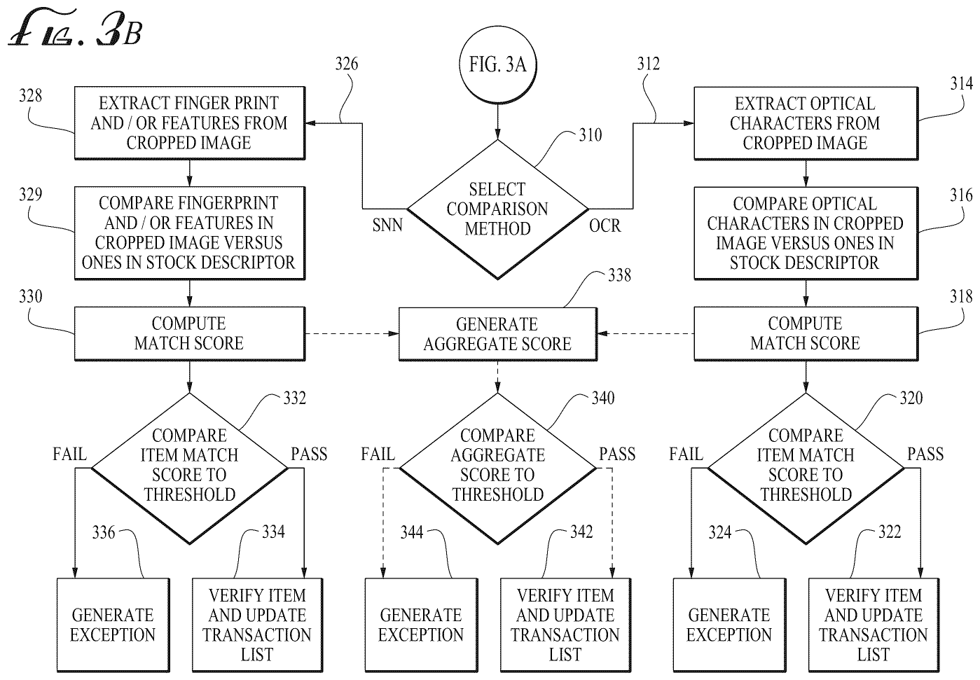

With reference to FIG. 3A, at step 302, the data reading system 10 obtains information for an item 20 (e.g., a barcode or other optical code data) as it is processed by the customer via the data reading system 10 during the checkout transaction. As described previously, in some checkout processes, the customer 38 may present the barcode on the items 20 to the scan windows 46, 48 for reading by the data readers 50, 52, or the customer may input an item description into the data reading system 10 via the display 54 to identify and process the item 20, or the customer 38 may take other suitable action to ensure the information for each item 20 in the transaction is received and processed by the data reading system 10. The item information obtained by the data reading system 10 includes one or more images of the item 20, where the images include (or may be stitched together to include) an optical code associated with the item 20. The item image(s) may include monochromatic images, color images, or both types of images depending on the configuration of the data reading system 10. FIG. 4 illustrates an example of an obtained item image 400 for the item 20, where the item 20 is a bottle of wine. As illustrated in FIG. 4, the obtained image 400 may include only a portion of the bottle of wine, where the image 400 includes the optical barcode 402 and any surrounding optical characters 404, such as numeric or alphanumeric characters or other suitable information.

At step 304, once the item information has been obtained by the data reading system 10, the processor 135 (such as via a decoding unit or other suitable module) receives the item image 400 and analyzes the item information to decode the optical code and identify the item 20. In the cases where item information is entered directly into the data reading system 10 via the display or other suitable fashion, the processor 135 processes that information to identify the item 20. As noted previously, in the example of FIG. 4, the processor 135 decodes optical code 402 and identifies the item as a bottle of wine.

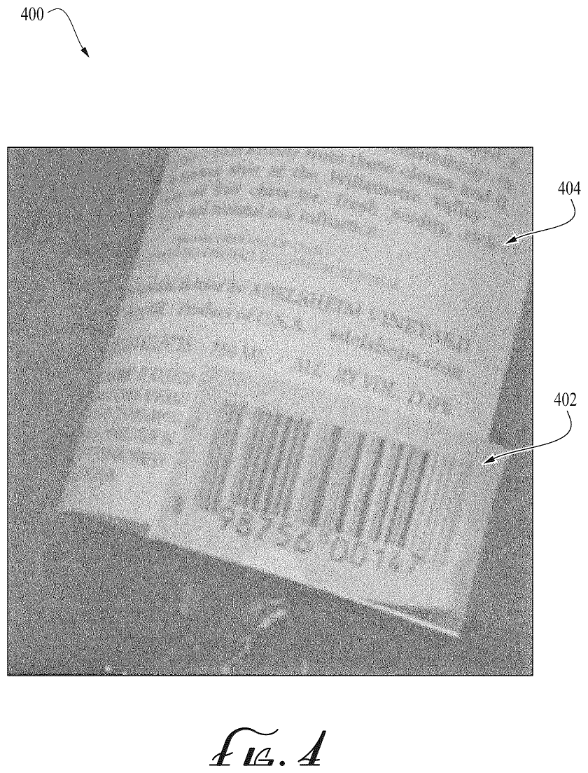

At step 306, the processor 135 queries a database (such as a locally-stored database, a database at the remote server 158, or from another suitable system) in communication with the data reading system 10, to retrieve reference image data, such as one or more reference descriptors associated with the item 20, where the query is based on the identification of the item 20 as made via the optical code 402 contained in the item image 400. Although the reference image data is depicted in FIG. 5 in an image format as a stock (i.e., reference) image 500, embodiments are not limited to using reference image data in an image format for its analysis. It is recognized and contemplated in embodiments of the disclosure that the reference image data retrieved and used in the analysis may be a descriptor that is in another format. The reference descriptor may include information derived from a reference image (e.g., raw or cropped image) of an item, such as the stock image 500 shown in FIG. 5 as an example. The image format shown in these examples is useful for providing a visual representation to assist with an understanding of the underlying process. The retrieved descriptor may include relevant data such as text information (e.g., alphanumeric characters, words, phrases, etc.), text size, font type, location information (e.g., coordinate information relative to a reference point such as the barcode) as described below with respect to FIG. 10. In some embodiments, the reference image data used in the analysis may be the stock image such that a plurality of stock images in an image format may be stored for analysis locally and/or remotely for retrieval during the checkout transaction. Retrieving descriptors instead of the stock images themselves may be desirable for reducing the computational complexity and data storage requirements, which may enable more tasks to be performed by an embedded system within the data reader by having lower processing and storage requirements.

In the provided example, the item 20 was identified as a bottle of wine during the checkout transaction, in which case, the processor 135 obtains the reference image data for that particular bottle of wine. FIG. 5 illustrates an example reference image data 500 for the bottle of wine, from which a reference descriptor may have been derived. As illustrated, the reference image data may include key identification information associated with the particular product, such as the optical barcode 502 and any surrounding optical characters 504, such as numeric or alphanumeric characters or other suitable information, words, phrases, text size, font type, font attributes (e.g., bold), location information (e.g., relative to the barcode), or other suitable information, which can be in a format other than an image format.

As illustrated in FIG. 5, the stock image 500 may include a cropped portion of the product label for the bottle of wine including the key identification information that may be helpful in a comparison process further discussed in detail below. The reference descriptor may be derived from the stock image associated to the item. In some embodiments, the stock descriptor derived from the image 500 may include information from the image that focuses on an area surrounding the optical code 502 and may be expanded to the left, right, top, and bottom from the four corners of the optical code 502 for a predetermined number of pixels to capture any optical characters 504 adjacent the optical code 502. Using a cropped image allows for a streamlined process and less computationally intensive analysis since the cropped image reduces the amount of information in the image for comparison as further discussed below.

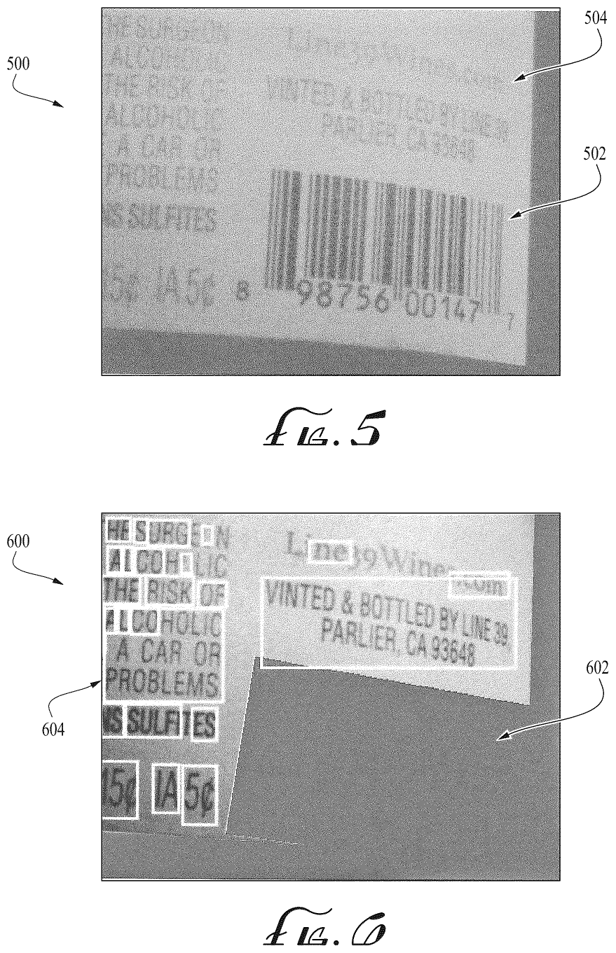

At step 308, the processor 135 (or other suitable module) defines a region-of-interest for the obtained item image 300 to closely align the information in the item image 300 with that used to generate in the stock descriptor associated to the image 500 to simplify the comparison process. Accordingly, in some embodiments, the region-of-interest may be defined to generally match the parameters of the descriptor associated to the reference image data 500 for the respective item 20. Using the optical code 502 in the reference image data 500 as a general guide for simplicity, the obtained image 300 of FIG. 3A may be cropped in pixels according to the size, location, and orientation of the optical code 502 in the reference image data 500 to generate a cropped image 600 that generally resembles the reference image data 500. As illustrated in FIG. 6, the cropped image 600 includes the optical code 602 and is expanded to the left, right, top, and bottom from the four corners of the optical code 602 for substantially the same predetermined number of pixels applied to the reference image data 500 to capture adjacent text and information 604. The result of this process is a cropped image 600 that includes a similar layout and dimensions as the reference image data 500 to simplify the item validation process and improve the accuracy of the match score.

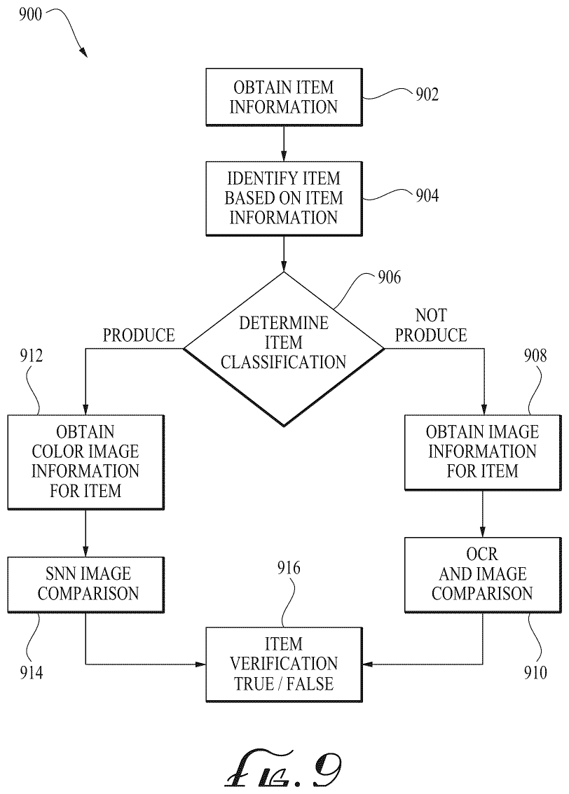

Turning to FIG. 3B, at step 310, the processor 135 selects a comparison method for comparing item features or other image information contained in the reference descriptor associated to the reference image data (e.g., stock image 500) to corresponding item features or image information contained in the cropped image 600 to verify that the item 20 as presented to the data reading system 10 is the item it is purported to be. In particular, the comparison seeks to identify instances where the optical code for the item 20 has been manipulated and replaced with an optical code for another product, often a lower cost item. In some embodiments, the selection at step 310 may be made based on an item classification for the identified item being processed. For example, the database may classify all items available for purchase into various item classes, such as classifications based on item price, assessed risk factor for theft, or other suitable item category (such as goods with optical codes embedded in the product packaging vs. items with optical codes on sticker labels, such as meat and produce). In these embodiments, the processor 135 may select a more rudimentary analysis method (e.g., a method that is less computationally complex yielding a lower confidence level) for less expensive items or items with a low risk factor for theft and may select a more complex analysis method (e.g., a method that is more computationally complex yielding a higher confidence level) for more expensive items or items with high risk factors for theft. For the various item categories, the processor may select a more rigorous analysis method for meat or produce since those may be more susceptible to optical code manipulation as compared to packaged goods with optical code information embedded on the packaging. The method 900 of FIG. 9 provides an example embodiment of such a data reading system and analysis process.

The comparison analysis may incorporate any one of various suitable analysis techniques. For example, in one embodiment, an optical character recognition (OCR) process may be used to efficiently recognize numeric and alphanumeric text present in the images 500, 600 for expedient comparison. In another embodiment, a more complex system, such as a twin neural network, may be used for more complex fingerprint matching. The method steps described below incorporate both processes for improved performance and flexibility, but it should be understood that other image analysis algorithms, such as SIFT (Scale-Invariant Feature Transform) or SURF (Speeded Up Robust Features) methods, and any combination thereof, may also be incorporated.

If the processor 135 determines to employ an OCR technique to compare optical characters in the cropped image 600 with those in the stock descriptor associated to the image 500, selection step 310 proceeds along OCR branch 312. At step 314, the processor 135 processes the cropped image 600 to extract numeric and alphanumeric text present in the image to enable the OCR comparison. FIG. 6 illustrates an example of the detected text and information 604 for the cropped image 600, which includes a portion of the product label. In the example of FIG. 6, the text in the cropped image 600 may include a warning from the surgeon general, bottling information for the wine, and deposit information for returning the empty bottle. At step 316, the processor 135 compares the text extracted from the cropped image 600 to the text present in the descriptor associated to the reference image data 500. In some embodiments, the text for the reference image data 500 may be previously known and stored in the database, along with other meta-information listed above as possible data fields of the descriptor, to expedite processing. At step 318, the processor tallies the number of matching optical characters present in the cropped image 600 and the descriptor associated to the reference image data 500 and computes an item match score corresponding to a match rate for those optical characters.

At step 320, the processor 135 compares the item match score resulting from the comparison of the descriptor associated to the reference image data 500 and the discriminative information extracted, through the on-device image processing, from the image 600 to a predetermined threshold match score to assess whether to verify the transaction. In some embodiments, the threshold match score may be relatively low, such as simply requiring the matching of two or three words or the matching of 30-40% of the recognized optical characters, to minimize delays in the customer transaction. In other embodiments, the threshold match score may be adjusted depending on a particular characteristic of the item 20, such as price or identity. For example, more expensive items or items that are more likely to be stolen may require a higher threshold for verification, whereas less expensive items or rarely stolen items may require a lower threshold.

If the item match score equals or exceeds the threshold match score set for the particular item 20, this indicates with an acceptable degree of certainty that the processed item 20 was properly identified by the data reading system 10 for what it purports to be (i.e., the barcodes were not swapped between items). In this case, comparison step 320 proceeds along the PASS branch and, at step 322, the processor 135 verifies the transaction and updates the transaction list for the customer transaction to include the verified item 20. For reference, the comparison of the descriptor associated to the reference image data 500 (see FIG. 5) to the discriminative information extracted from the cropped image 600 (see FIG. 6) would result in a product verification since there is sufficient character matching between the two images (the labels are for the same product).

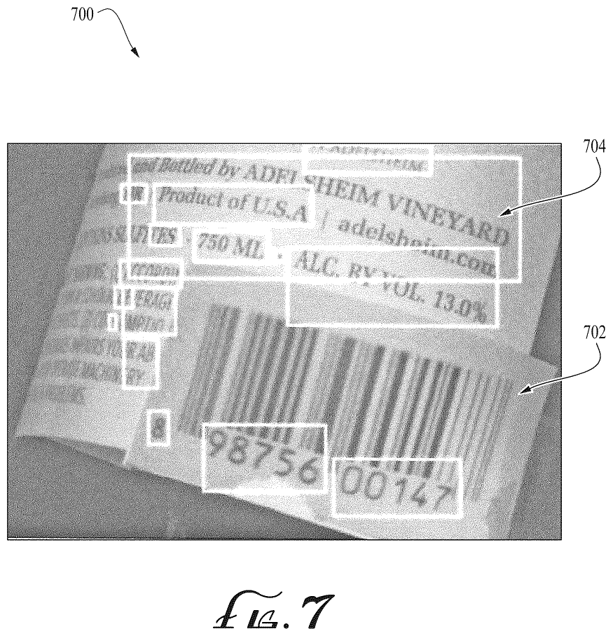

If, on the other hand, the item match score fails to equal or exceed the threshold match score, this may indicate an instance of label swapping or other issue that requires further attention by store personnel. For reference, the comparison of the descriptor associated to the reference image data 500 (see FIG. 5) to discriminative information extracted from the cropped image 700 (see FIG. 7) would result in a failed verification since there is little to no matching of the optical characters 504, 704 between the images 500, 700. In FIG. 7, the optical code 702 associated with the particular bottle of wine in reference image data 500 has been swapped onto a different bottle of wine. In this scenario, the data reading system 10 identifies the bottle of wine as the one in FIG. 5 during the checkout transaction based on the information in the optical code 702. However, the optical characters 704 surrounding the optical code 702 do not match those in the descriptor associated to the reference image data 500. In this scenario, comparison step 320 proceeds along the FAIL branch, and at step 324, the processor 135 generates an exception in response to the item match score failing to equal or exceed the threshold match score.

The exception may include an alert to the customer (such as via the display 54) and/or store personnel with a notice of the potential issue. In some embodiments, the processor 135 may send an image of the exception item to store personnel along with a reference to an image (such as the reference image data 500 or other suitable image related to the item) from the database for the item for further review and resolution. In other embodiments, the processor 135 may lock the data reading system 10 (or the processor 135 may be instructed to do so by store personnel) and suspend the transaction to restrict further item processing until the issue is resolved. If no issues are found, store personnel may resolve the exception and transmit instructions to the processor 135 for resolving the issue to release the exception item. If the discrepancy is confirmed by store personnel, the images for the items may be timestamped and saved for further processing or other diagnostic purposes. Such images and their associated extracted information may be used to update the models in some embodiments. In some embodiments, the processor 135 may further trigger the camera 56 to obtain an image of the customer 38 for reference in the event of an attempted theft. In some embodiments, such as for lanes attended by store personnel, the exception may be sent to a remote computer for central processing to ensure that the exception is cleared by some other than store personnel to help avoid situations where the store personnel is involved in the theft.

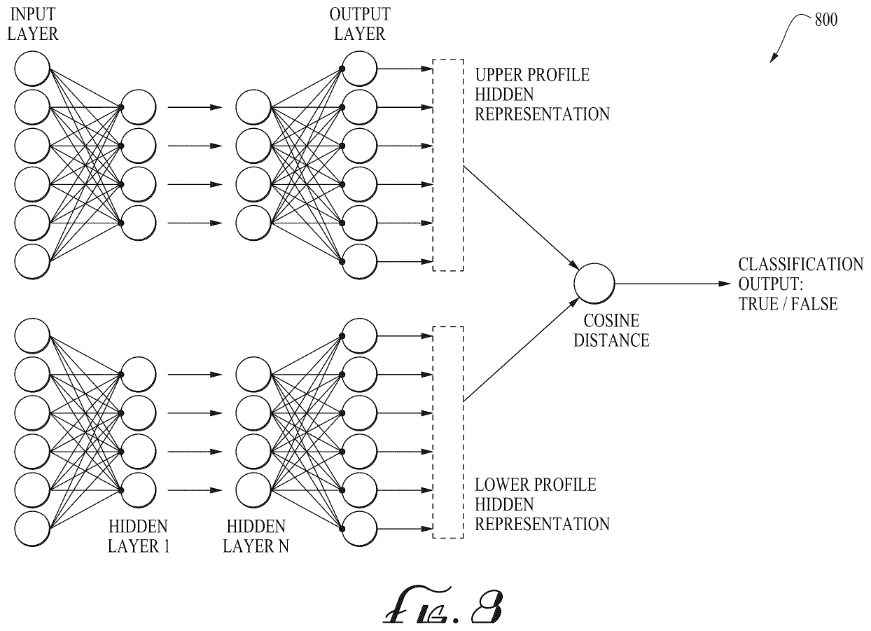

Returning to selection step 310, the processor 135 may also employ a trained object recognition model, such as a neural network, to perform the fingerprint-comparison process. Briefly, the neural network may be trained with image data representative of the items for sale in the retail establishment, where the image data may include images of the items, optical codes, and/or other optical characters, such as numeric and alphanumeric information. The neural network may be trained using a suitable machine learning program that involves identifying and recognizing patterns in existing data, such as image data of items 20 being processed via the data reading system 10. In the method 300, the object recognition model is preferably a Siamese (or Twin) Neural Network (SNN) containing any model architecture with at least two, parallel, identical Convolutional Neural Networks during the training phase to allow for the model to learn similarity instead of requiring direct classification. FIG. 8 illustrates an example SNN 800 in accordance with one embodiment.

To train the SNN, image data is introduced in such a way that each branch receives training examples. The SNN may employ Ranking Loss, which aims to predict relative distances between model inputs when projected onto a hyperspace. To use a Ranking Loss function, the following steps are performed. First, features from the input data points are extracted to get an embedded representation for each of them. The extracted features may be embedded onto a d-dimensional hyperspace. Thereafter, a metric function to measure similarity between those representations is defined, for instance Euclidian distance. Finally, feature extractors are trained to produce similar representations for inputs when the inputs are similar, or distant representations for the inputs when they are dissimilar. The actual values of the representations or embeddings is not typically important, but the distance between them is.

The embedded clustering makes SNNs a powerful tool. Once created, the model can be fine-tuned to account for additional classes if desired. In some embodiments, only the last few layers of the whole network architecture may be modified or fine-tuned while keeping the feature extraction backbone unmodified to allow for small modifications to the original model. Preferably, any new modifications are generated in such a way that, when plotted into the d-dimensional hyperspace, they are far away from the existing clusters, but cluster together with other examples of the new class as they are added. By using this embedded similarity, the SNN model can be used to produce likely classifications for both original and new classes possibly using very little data. When a new class of items is added, the image for the item may be saved and refined training for the model can be performed frequently to ensure optimal performance for the model.

Returning to FIG. 3B, if the processor 135 determines to apply an SNN technique to compare the fingerprint associated to the reference image data (e.g., stock image 500) with the fingerprint obtained running the SNN inference process on the captured image 400 during the transaction, selection step 310 proceeds along SNN branch 326. At step 328, the processor 135 applies the SNN inference process to the item image 400 obtained during the customer transaction for analysis. The result of the inference process is a fingerprint associated to the item image 400. At step 329, the fingerprint and/or other features generated from the captured image 400 may be compared to the related fingerprint and/or features included within the reference descriptor. At step 330, the processor 135 determines an item match score based on the output vector distance between the two fingerprints: the one associated to the item image 400 and the other associated to the stock image 500 and computes an item match score. At step 332, the processor 135 compares that item match score to a threshold match score to determine whether the images 400, 500 match for verifying the transaction.

If the item match score equals or exceeds the threshold match score, the comparison step 332 proceeds along the PASS branch, and at step 334, the processor 135 verifies the transaction updates the transaction list to include the verified item 20. If, on the other hand, the item match score fails to equal or exceed the threshold match score, this may indicate an instance of label swapping or other issue that requires further attention by store personnel. In this scenario, the comparison step 332 proceeds along the FAIL branch, and at step 336, the processor 135 generates an exception in a similar fashion as described above with reference to step 324. As noted above, the exception may include an alert to the customer (such as via the display 54) and/or store personnel with a notice of the exception. In some embodiments, the processor 135 may send an image of the exception item to store personnel for further review and resolution and may lock the data reading system 10 to restrict further item processing until the issue is resolved. Store personnel may resolve the exception and transmit instructions to the processor 135 for resolving the issue. In some embodiments, the processor 135 may further trigger the camera 56 to obtain an image of the customer 38 for reference in the event of an attempted theft.

In some embodiments, the method 300 may apply both the OCR technique and the SNN technique described in the steps above to improve the accuracy of the analysis if desired. In such embodiments, the method 300 may proceed in a similar fashion as described above with reference to those respective techniques. In other words, the OCR technique may proceed as described in steps 314, 316, and 318 and the SNN technique may proceed as described in steps 328, 330. Upon the completion of those respective steps, the method 300 proceeds with step 338, where the processor 135 receives the item match scores from both the OCR and SNN techniques and determines an aggregate match score based on a combination of the respective item match scores for the OCR technique and the SNN technique. Thereafter, at step 340, the processor 135 compares the aggregate match score against a threshold match score. If the aggregate score equals or exceeds the threshold match score, the comparison step 340 proceeds along the PASS branch, and at step 342, the processor 135 verifies the transaction and updates the customer list with the verified item. If the aggregate match score fails to equal or exceed the threshold match score, the comparison step 340 proceeds along the FAIL branch, and at step 344, the processor 135 does not verify the transaction and instead generates an exception in a similar fashion as described with respect to steps 324, 336, where the exception requires further attention from store personnel in a similar fashion as described with reference to steps 322, 334 above.

In some embodiments, the results of the comparison process may be saved in the database to obtain various sources of potentially valuable information, such as: information on items commonly involved in attempted theft, information relating to time, date, employees on shift, and store location where attempted theft most often occurs, and items with higher rates of exceptions or discrepancies. This information may be used to identify larger-scale issues that may otherwise be difficult to discern. For example, information relating to the time, date, and store location where discrepancies occur may be cross-referenced with employment and shift information to determine whether any employees are directly stealing items or involved with other customers to do so. Similarly, information about commonly stolen items may be tracked and used to update the parameters of the data reading system 10 to ensure additional scrutiny (e.g., higher threshold scores, more rigorous analysis techniques, etc.) is applied to those items.

As described above, the method 300 of FIGS. 3A and 3B relates to an analysis process where the data reading system 10 is designed to select a comparison technique or combine multiple techniques to analyze an image of the item 20 obtained during a data reading process and compare that obtained image to a known stock descriptor of the item to verify the item and the transaction. FIG. 9 is a flowchart of a method 900 in accordance with another embodiment where the data reading system 10 determines which analysis technique from a plurality of available analysis techniques based on a classification of the item being processed as discussed briefly with reference to step 310 of method 300. It should be understood that in the following discussion, many of the same details for the steps described with reference to method 900 are the same or similar as corresponding steps described with reference to method 300. Accordingly, some details in method 900 may not be described in further detail below to avoid repetition, but it should be understood that the details of steps with reference to method 300 apply equally to corresponding steps in the method 900.

With reference to FIG. 9, at step 902, the data reading system 10 obtains information for an item 20 (e.g., a barcode or other optical code data) as it is processed by the customer via the data reading system 10 during the checkout transaction. As described previously, the data reading system 10 may obtain the information via the data readers 50, 52 or may receive item information input by the customer, such as by entering a product name, product ID, or other suitable information via the display 54. At step 904, once the item information has been obtained by the data reading system 10, the processor 135 identifies the item (such as a via a decoding unit or other suitable module).

Once the item 20 has been identified, at step 906, the processor 135 determines an item classification for the item 20 based on the identity. The item classification for each item may be designated and stored in the database along with the stock image and other information for each item, and may include any suitable categories and may differ across various retail establishments. For example, as noted previously, the items 20 may be classified in accordance with price, assessed risk factor for theft, item type (e.g., bulk items sold by weight, produce, meat, packaged goods, etc.) or other suitable categories. Classifying items may be beneficial for various reasons. For example, an OCR technique is relatively simple and can be used to efficiently compare images for the items being processed. However, this technique is best suited for comparing optical characters (such as letters and numbers found on a product label) between images but is less effective for processing produce or items sold by weight since those items tend not to have many optical characters for comparison. Similarly, the Siamese Neural Network technique described above may be able to handle a wider range of items for comparison, but the technique is computationally intensive, requires ongoing network training for optimal performance, and may result in processing delays for the customer transaction. Accordingly, allowing the processor 135 to select the comparison technique based on the item classification optimizes overall performance of the system.

In the example in FIG. 9, the method 900 proceeds with an item classification based on whether the item 20 is classified as produce or not. It should be understood that this configuration is simply an example for reference purposes, and the item classification for selecting the appropriate comparison technique may differ in other embodiments. That said, using produce as the selected item classification for driving the method 900 may be beneficial when using the data reading system 10 in a grocery store both to optimize system performance and for practical reasons. As noted above, the OCR technique performs well for packaged goods and most other non-produce items, and the SNN technique is well suited for handling comparison analysis for produce. Moreover, as noted previously, optical codes on produce are usually affixed via a sticker label or other easily removable label. As such, labels for produce tend to be used when customers are attempting to obtain expensive items at a lower cost (e.g., swapping a sticker label for bananas with the label on a package of steak).

With reference to FIG. 9, as noted above, the processor 135 at step 906 determines whether the item 20 is classified as produce or not produce based on the identity of the item determined at step 904. If the item 20 is classified as not produce, the determination step 906 proceeds along the NOT PRODUCE branch, where at step 908, the data reading system 10 obtains one or more images of the item 20 via the data readers 50, 52. In some embodiments, the data readers 50, 52 may have already obtained images of the items prior to identifying and classifying the item. However, for produce or other items, the data reading system 10 may also identify the item based on information keyed into or otherwise input into the data reading system 10, such as via the display 54. Accordingly, in some instances, the item 20 may be processed and identified without first obtaining an image of the item 20.

At step 910, the processor 135 proceeds with the OCR comparison technique in a similar fashion described with reference to method 300, particularly with respect to steps 306, 308, 314, 316, 318, 320, to determine whether to verify the transaction. To avoid duplication, additional detail of the OCR process is not further described herein, but it should be understood that the relevant details from method 300 apply equally to method 900.

Returning to determination step 906, if the item 20 is classified as produce, the determination step 906 proceeds along the PRODUCE branch, where at step 912, the data reading system 10 obtains one or more images of the item 20. In some embodiments, the data reading system 10 may obtain color images of the item 20 (such as via color data readers 116, 126 of FIG. 2) to capture additional detail of the item 20 and improve the comparison process. Thereafter, at step 914, the processor 135 proceeds with the comparison using the SNN technique in a similar fashion described with reference to method 300, particularly with respect to steps 306, 308, 328, 330, 332. To avoid duplication, additional detail of the SNN process is not further described herein, but it should be understood that the relevant details from method 300 apply equally to method 900.

At step 916, for either comparison technique (OCR or SNN or a combination thereof), the results of the comparison are evaluated against a threshold value in a similar fashion as described previously to determine whether to verify the transaction. Based on the results of the comparison, the processor 135 may verify the transaction and update the transaction list to include the item 20 as described with reference to steps 322, 334 or generate an exception indicating there is an issue with the transaction and requiring intervention from store personnel as described with reference to steps 324, 336 above.

In another embodiment, the comparison technique of method 900 may be streamlined to target specific items that are commonly stolen or commonly involved in theft of other items. Briefly, in such embodiments, method 900 may proceed as described above with reference to steps 902, 904. At step 906, in addition to determining whether the item is classified as produce, the processor 135 may determine whether the item is also classified as a commonly shoplifted item. If so, the method 900 may proceed as described above with reference to FIG. 9. If not, the method 900 may skip the analysis process altogether and simply verify the item. This configuration for the data reading system 10 may minimize the requirements for the matching database and streamline the overall customer transaction by having the data reading system 10 focus primarily on commonly stolen items.

FIG. 10 is a representation of a stock descriptor 1000 according to an embodiment of the disclosure. As described above, the stock descriptor 1000 may include information derived from a stock image and may be stored in a format that is not an image format, such as a text format, a binary format, etc. The information of the stock descriptor 1000 may be organized based on the type of analysis for which the information is used. For example, information useful for the OCR analysis 1002 may include text data, positional data (e.g., coordinates relative to a reference point such as the barcode), font type, background color, foreground color, and other relevant information (e.g., font attributes such as size, bolt, italics, etc.). Information useful for the fingerprint analysis 1004 (e.g., SNN) may include n-dimensional vector(s), tensor(s), etc. Other features 1006 may be included that may be useful in other forms of analysis, including SIFT features, SURF features, color histogram information, etc.

In some embodiments, each item may have a single descriptor that includes information relevant to the OCR analysis (e.g., steps 312-318 above) as well as information relevant to the fingerprint analysis (e.g., steps 326-330 above) or other analysis. In some embodiments, items may be associated with multiple descriptors, such as a first descriptor having just the information relevant to the OCR analysis and a second descriptor having just the information relevant to the fingerprint analysis. In that case, the first descriptor for the item is retrieved during the OCR analysis and the second descriptor is retrieved during the fingerprint analysis. In some embodiments, items may have multiple descriptors that may be associated with different variations of the item, such as seasonal packaging or other variations of the same item. In that case, when descriptors are retrieved for the analysis, multiple descriptors may be retrieved if available for the same item.

In some embodiments, the descriptors for the plurality of items supported by the system may be stored in a local database of the data reader (e.g., an embedded database), in a remote database (e.g., a cloud-based database), and/or a combination of each. In some embodiments, a local cache of descriptors may be stored locally within the data reader. The local cache may include descriptors that are selected based on being of particular interest (e.g., most common items scanned, most common items used in fraudulent transactions, most common items stolen, price considerations, items currently in stock, etc.). Thus, when retrieving the descriptors (e.g., step 306 in FIG. 3), the processor may first check if the descriptor is in the local cache of descriptors before requesting the descriptors from the remote server. This tiered storage of such descriptors may result in faster response times and lower embedded storage requirements within the data reader.

FIG. 11A is a simplified block diagram of a data reading system 1100 performing an update process 1150 according to an embodiment of the disclosure. FIG. 11B is a flowchart illustrating the update process 1150. The data reading system 1100 includes the data reader and a remote host (e.g., data center) that may be configured to perform updates such as OCR web services, NN training, etc. With reference to FIG. 11B, the update process 1150 may be in response to a trigger 1152 (e.g., add a new item, low accuracy of an item, new package for pre-existing items, etc.) in which the remote host may receive image data 1154 (e.g., images, extracted features from images, locally generated descriptors from such images, user validation information, etc.). The collected image data 1154 may be used by the remote host to update the models 1156 and/or the descriptors used by the models 1158. The updates provided to the data reader 1100 may result in a model being updated on the data reader 1160 or in the local descriptor database being updated on the data reader 1162.

It should be understood that in other embodiments, certain steps described in method 300 of FIGS. 3A and 3B, method 900 of FIG. 9, and other methods described herein may be combined, rearranged, altered, varied, and/or omitted without departing from the principles of the disclosed subject matter. It is intended that subject matter disclosed in portion herein can be combined with the subject matter of one or more of other portions herein as long as such combinations are not mutually exclusive or inoperable. In addition, many variations, enhancements and modifications of the systems and methods described herein are possible.

The terms and descriptions used above are set forth by way of illustration only and are not meant as limitations. Those skilled in the art will recognize that many variations can be made to the details of the above-described embodiments without departing from the underlying principles of the invention.

1. A data reading system comprising:
a housing supporting a scan window;
one or more data readers disposed within the housing, each data reader having a field-of-view directed through the scan window, wherein each data reader is operable to capture an item image of an item as the item passes across the scan window during a customer transaction;
a database having stored therein reference image data for the item; and
a processor operable to receive the item image from at least one of the one or more data readers for the item and identify the item from the item image, wherein after identifying the item, the processor is further configured to:
query the database and obtain the reference image data for the item;
compare one or more item features in the reference image data to a corresponding one or more item features in the item image;
compute an item match score corresponding to a match rate of the one or more item features in the reference image data to the one or more item features in the item image;
compare the item match score to a threshold match score; and
generate an exception in response to the item match score failing to equal or exceed the threshold match score.

2. The data reading system of claim 1, wherein for the identified items, the processor is further configured to:
verify the item in response to the item match score for the item equaling or exceeding the threshold match score; and
update a transaction list associated with the customer transaction with item information for the verified item.

3. The data reading system of claim 1, wherein the threshold match score is based on an item class for the item.

4. The data reading system of claim 1, wherein the reference image data includes a first optical code and a first set of optical characters including one or both of numeric and alphanumeric text adjacent the first optical code, and wherein the item image includes a second optical code and a second set of optical characters including one or both of numeric and alphanumeric text adjacent the second optical code, the processor further configured to:
define a region-of-interest in the captured item image, the region-of-interest containing the second optical code and the second set of optical characters; and
crop the captured item image to define a cropped image containing the region-of-interest,
wherein the processor comparing one or more item features of the reference image data to a corresponding one or more item features of the item image includes the processor comparing the first set of optical characters in the reference image data to the second set of optical characters in the region-of-interest of the cropped image.

5. The data reading system of claim 4, where the processor is further configured to:
compute an optical character match score based on the comparison of the first set of optical characters in the reference image data to the second set of optical characters in the region-of-interest of the cropped image;
compare the one or more item features of the reference image data to the one or more item features of the item image using a trained neural network;
compute a neural network match score based on the comparison; and
determine a combined item score based on an aggregate of the optical character match score and the neural network match score, wherein the item match score includes the combined item score.

6. The data reading system of claim 1, wherein the processor is further configured to:
classify the identified item into an item class based on the identity of the item; and
select an analysis algorithm from a plurality of available analysis algorithms for comparing one or more item features of the reference image data to the corresponding one or more item features of the item image, wherein the selection of the analysis algorithm is based on the item class of the item.

7. The data reading system of claim 1, wherein the reference image data further includes one or more reference descriptors associated with the item, wherein the one or more reference descriptors includes any of: text information, text size, font type, or coordinate information for a reference feature associated with the item.

8. The data reading system of claim 1, wherein after generating the exception, the processor is further configured to transmit the item image captured by the data reader from the data reading system to a remote computer, wherein the processor is further configured to receive and execute instructions from the remote computer for resolving the exception.

9. The data reading system of claim 1, wherein the processor configured to compare one or more item features of the reference image data to the corresponding one or more item features of the item image further includes the processor employing a neural network for the comparison, the processor further configured to update neural network training parameters in response to validation feedback received, wherein the validation feedback includes exception feedback based on handling of the exception when the item match score fails to equal or exceed the threshold match score and verification feedback when the item match score for the item equals or exceeds the threshold match score.

10. A data reading system comprising:
a housing supporting a scan window;
one or more data readers disposed within the housing, each data reader having a field-of-view directed through the scan window, wherein each data reader is operable to capture an item image of an item as the item passes across the scan window during a customer transaction;
a database having stored therein reference image data for the item, the database further including classification information for the item, the classification information including at least a first item class and a second item class; and
a processor operable to receive the item image from at least one of the one or more data readers for the item and identify the item from the item image, wherein after identifying the item, the processor is configured to classify the item into one of the first item class or the second item class based on the identity of the item,
wherein in response to the processor classifying the item in the first item class, the processor is further configured to:
query the database and obtain the reference image data for the item, wherein the reference image data includes a first optical code and a first set of optical characters including one or both of numeric and alphanumeric text adjacent the first optical code;
compare the first set of optical characters in the reference image data to a second set of optical characters in the item image;
compute an optical character match score based on the comparison of the first set of optical characters in the reference image data to the second set of optical characters in the item image;
compare the optical character match score to a threshold optical character match score; and
generate an exception in response to the optical character match score failing to equal or exceed the threshold optical character match score, and wherein in response to the processor classifying the item in the second item class, the processor is further configured to:
query the database and obtain the reference image data for the item;
compare one or more item features in the reference image data to a corresponding one or more item features in the item image using a trained neural network;
compute a neural network match score based on the comparison; and
generate an exception in response to the neural network match score failing to equal or exceed the threshold neural network match score.

11. A method of data reading via a data reading system, the method comprising:
capturing, via one or more data readers, an item image of an item as the item passes across a scan window of the data reading system during a customer transaction;
identifying, via a processor, the item from the item image received from at least one of the one or more data readers;
querying, via the processor, reference image data for the item stored in a database;
comparing, via the processor, one or more item features in the reference image data to a corresponding one or more item features in the item image;
computing, via the processor, an item match score corresponding to a match rate of the one or more item features in the reference image data to the one or more item features in the item image;
comparing, via the processor, the item match score to a threshold match score; and
generating, via the processor, an exception in response to the item match score failing to equal or exceed the threshold match score.

12. The method of claim 11, further comprising:
verifying, via the processor, the item in response to the item match score for the item equaling or exceeding the threshold match score; and
updating, via the processor, a transaction list associated with the customer transaction with item information for the verified item.

13. The method of claim 11, further comprising:
communicating, via the processor, the exception to a remote computer in operable communication with the data reading system;
locking, via the processor, the data reading system to prevent the one or more data readers from capturing a second item image for a second item;
receiving, via the processor, instructions for resolving the exception from the remote computer; and
unlocking, via the processor, the data reading system in response to the received instructions.

14. The method of claim 11, the method further comprising:
capturing, via a camera, an image of a customer associated with the transaction in response to the processor generating an exception; and
transmitting, via the processor, the image of the customer from the camera to a remote computer.

15. The method of claim 11, wherein the reference image data further includes one or more reference descriptors associated with the item, wherein the one or more reference descriptors includes any of: text information, text size, font type, or coordinate information for a reference feature associated with the item.

16. The method of claim 11, further comprising:
classifying, via the processor, the item into an item class based on the identity of the item; and
selecting, via the processor, based on the item class for the item, an analysis algorithm from a plurality of available analysis algorithms for comparing the one or more item features of the reference image data to the corresponding one or more item features of the item image.

17. The method of claim 11, wherein the step of comparing, via the processor, the one or more item features in the reference image data to the corresponding one or more item features in the item image, further comprises:
defining, via the processor, at least one region-of-interest in the captured item image, the at least one region-of-interest including the one or more item features in the item image;
comparing, via the processor, the one or more item features in the reference image data to the corresponding one or more item features in the at least one region-of-interest in the captured item image using a first analysis technique; and
comparing, via the processor, the one or more item features in the reference image data to the corresponding one or more item features in the at least one region-of-interest in the captured item image using a second analysis technique different from the first analysis technique.

18. The method of claim 17, wherein the first analysis technique and the second analysis technique are selected from the group including an optical character recognition (OCR) analysis, a neural network analysis, a scale-invariant feature transform (SIFT) analysis, or a speeded up robust features (SIFT) analysis.

19. The method of claim 17, the method further comprising:
computing, via the processor, a first match score for the first analysis technique based on the comparison of the one or more item features in the reference image data to the corresponding one or more item features in the item image;
computing, via the processor, a second match score for the second analysis technique based on the comparison of the one or more item features in the reference image data to the corresponding one or more item features in the item image;
determining, via the processor, a combined match score based on an aggregate of the first match score and the second match score; and
comparing, via the processor, the combined match score to a threshold match score.

20. The method of claim 11, wherein the step of comparing, via the processor, the one or more item features in the reference image data to the corresponding one or more item features in the item image further comprises applying, via the processor, a trained neural network to both the reference image data and the item image, the method further comprising:
receiving, via the processor, exception feedback based on handling of the exception when the item match score fails to equal or exceed the threshold match score;
receiving, via the processor, verification feedback when the item match score for the item equals or exceeds the threshold match score; and
updating, via the processor, training parameters of the trained neural network based on the exception feedback and the verification feedback.
